(19) United States
(12) Patent Application Publication
(10) Pub. No.: US 2008/0240158 A1
(43) Pub. Date: Oct. 2, 2008

(54) METHOD AND APPARATUS FOR SCALABLE STORAGE FOR DATA STREAM PROCESSING SYSTEMS

(76) Inventors: Eric Bouillet, Englewood, NJ (US); Parijat Dube, Yorktown Heights, NY (US); Mark D. Feblowitz, Winchester, MA (US); David A. George, Somers, NY (US)

Correspondence Address: Patterson & Sheridan, LLP, Suite 100, 595 Shrewsbury Avenue, Shrewsbury, NJ, 07702, US

(21) Appl. No.: 11/694,286

(22) Filed: Mar. 30, 2007

(51) Int. Cl. H04J 3/24

(52) U.S. Cl. 370/473

(57) ABSTRACT

In one embodiment, the invention is a method and apparatus for scalable storage for data stream processing systems. One embodiment of a system for processing a data stream, includes a first set of processing elements configured for processing of at least the lightweight portion of an information unit and a second set of processing units configured for storage of the heavyweight portion of the information unit.

### REFERENCE TO GOVERNMENT FUNDING

This invention was made with Government support under Contract No. H98230-05-3-001, awarded by Intelligence Agency. The Government has certain rights in this invention.

### BACKGROUND OF THE INVENTION

The present invention generally relates to data stream processing, and more particularly relates to storage for data stream processing systems.

Unstructured information represents the largest, most current and fastest growing source of knowledge available to businesses and governments. This information is typically processed in real time by high-performance data stream processing systems.

FIG. 1 is a block diagram illustrating an exemplary data stream processing system 100. The system 100 comprises a plurality of processing units 102₁-102ₙ (hereinafter collectively referred to as “processing units 102”) communicatively coupled via channels 104₁-104ₙ (hereinafter collectively referred to as “channels 104”). In the system 100, data is passed as information units (e.g., messages) 106₁-106ₙ (hereinafter collectively referred to as “information units 106”) to the processing units 102 for processing (e.g., origination, termination, analysis, transformation, etc.).

FIG. 2 is a block diagram illustrating an exemplary information unit 200. The information unit 200 enters a data stream processing system in an essentially raw form and comprises a payload 202 and annotations 204. The payload 202 depicts the full content of some understood form of information, while the annotations 204 comprise key/value pairs (the key representing the hierarchical name of a field value and carrying an Unstructured Information Management Architecture (UIMA)-based data type). The information unit 200 may be split (e.g., by a processing unit such as one of the processing units 102 illustrated in FIG. 1) into a first, lightweight information unit 206 comprising the annotations 204, a retrieval key and other potentially “interesting” data and a second, heavyweight information unit 208 comprising bulk data (i.e., the payload 202 and essential annotation). The first and second information units 206 and 208 each additionally comprise a common “reference” annotation that affirms membership of information as one unit.

The first, payload-free information unit 206 is advanced to analytic processing stages (executed by a plurality of processing units), while the second information unit 208 is sent to storage. Any processing unit may later access data needed to refine content interpretation from the second information unit 208 using the retrieval key. Eventually, unused data from the second information unit 208 is either discarded or transformed into a reporting form (such that the retrieval key is no longer required). Subsequently, all information units are discarded at a time of egress of last access.

Typical data stream processing systems employ a server running a sophisticated database to provide scalable archiving of data. However, scalability issues remain for massively expanded data stream processing applications, no matter how robust the use of the database server is. This is due, in part, to the “distance” of the processing units from the database server, which can add network hops and congestion, slowing connectivity for data storage and retrieval. The need to maintain indices and other data storage artifacts that permit rapid data retrieval also adds to the cost of maintaining a repository.

Therefore, there is a need in the art for a method and apparatus for scalable storage for data stream processing systems.

### SUMMARY OF THE INVENTION

In one embodiment, the invention is a method and apparatus for scalable storage for data stream processing systems. One embodiment of a system for processing a data stream, includes a first set of processing elements configured for processing of at least the lightweight portion of an information unit and a second set of processing units configured for storage of the heavyweight portion of the information unit.

### BRIEF DESCRIPTION OF THE DRAWINGS

The teachings of the present invention can be readily understood by considering the following detailed description in conjunction with the accompanying drawings, in which:

FIG. 1 is a block diagram illustrating an exemplary data stream processing system;

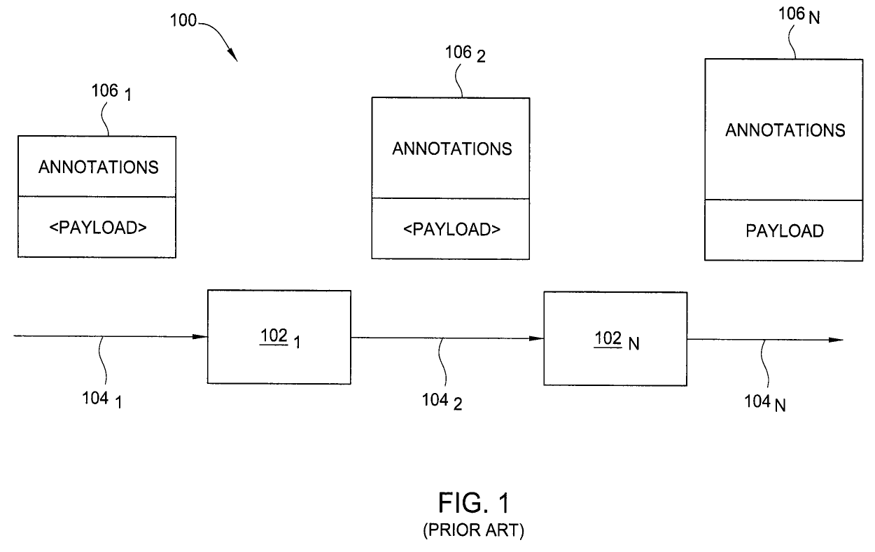

FIG. 2 is a block diagram illustrating an exemplary information unit;

FIG. 3 is a block diagram illustrating one embodiment of a data stream processing system, according to the present invention; and

FIG. 4 is a block diagram illustrating one embodiment of scalable storage for a data stream processing system, according to the present invention.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention is a method and apparatus for scalable storage for data stream processing systems. Embodiments of the invention provide many advantages over traditional data stream processing systems. By arranging processing units in a delay ring and allowing them to be raveled through advanced processing units, the “distance” between the advanced processing units and the delay ring storage can be minimized. This relieves network hops and congestion, thereby speeding connectivity for data storage and retrieval. Moreover, the system eliminates or reduces the need for costly disk storage and index table maintenance.

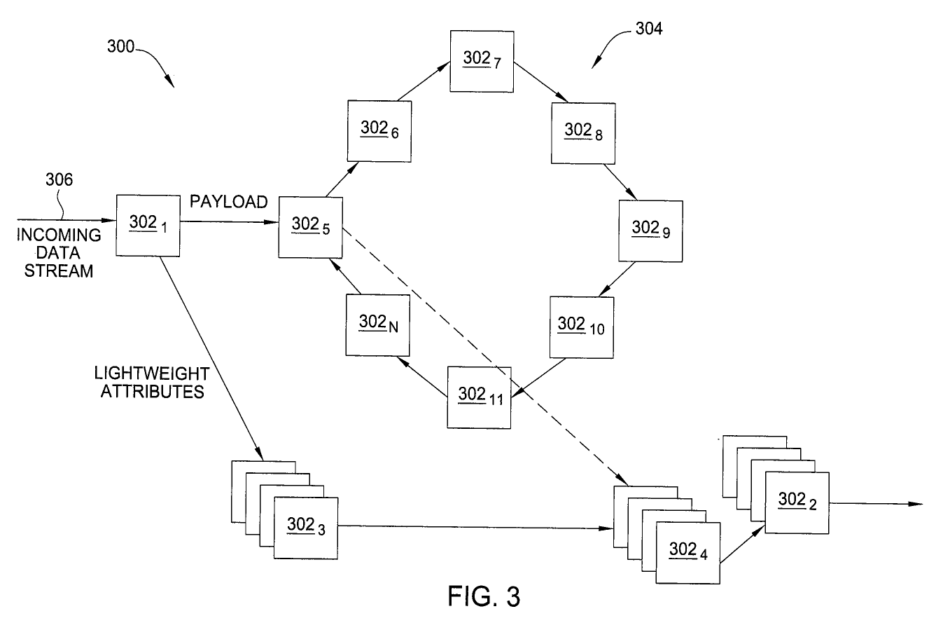

FIG. 3 is a block diagram illustrating one embodiment of a data stream processing system 300, according to the present invention. Like the system 100, the system 300 comprises a plurality of communicatively coupled processing units 302₁-302ₙ (hereinafter collectively referred to as “processing units 302”). A first set of these processing units 302 (e.g., processing units 302₂-302₄ of FIG. 3) is adapted for advanced processing of lightweight information units (i.e., annotations, retrieval keys and other potentially “interesting” non-payload data separated from an original message). A second set of the processing units 302 (e.g., processing units 302₅-302ₙ of FIG. 3) is configured for storage of payload-carrying information units (i.e., separated from an original message). In one embodiment, the processing units 302 that are used for storage of payload-carrying information units are configured as at least one delay ring 304.

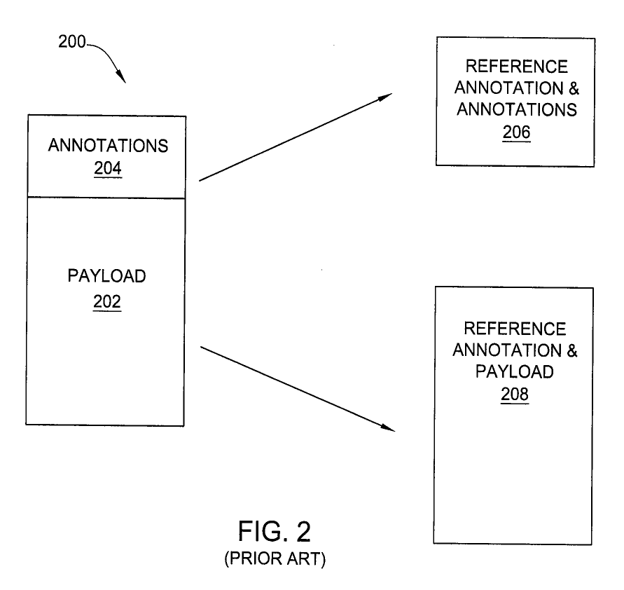

In practice, an incoming data stream 306 is received by a processing unit 3021, and original information units from the data stream 306 are split into a first, lightweight information units (comprising annotations, retrieval keys and other potentially “interesting” data) and second, heavyweight information units comprising bulk data (i.e., the payload and essential annotation), as discussed above with respect to FIG. 2. The first information units are forwarded to the first set of processing units 302 for advanced processing. The second information units enter the delay ring 304, where the second information units are constantly re-circulated (i.e., stored and forwarded in a cyclic manner) through the processing elements 302.

If a processing unit 302 in the first set of processing units requires a bulk data item corresponding to a given first information unit, the processing unit 302 uses the retrieval key in the first information unit to set a “flow criteria” for accepting a copy of the second information unit (i.e., the second information unit that corresponds to the first data unit) from a desired point on the delay ring 304, as illustrated in phantom by stream connection 308. The more points that are collected across a sparse setting, the lower the latency will be to retrieve the re-circulating second information unit. The original information unit (i.e., comprising the corresponding first information and second information unit) is only discarded when some final use of the data is performed or transformed, and the performance or transformation is broadcast by a finalizing processing unit 302. In one embodiment, the second information unit is discarded when the corresponding first information unit is discarded.

The system 300 provides many advantages over traditional data stream processing systems. By allowing the processing units (e.g., 302₅-302ₙ) in the delay ring 304 to be raveled through advanced processing units (e.g., 302₂-302₄), the “distance” between the advanced processing units and the delay ring storage can be minimized. Moreover, the system 300 eliminates or reduces the need for costly disk storage and index table maintenance.

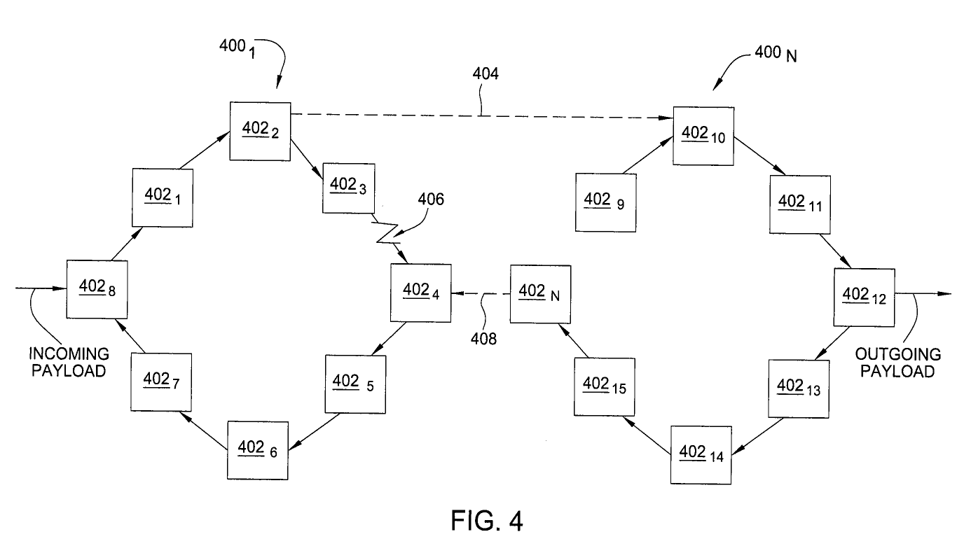

FIG. 4 is a block diagram illustrating one embodiment of scalable storage for a data stream processing system, according to the present invention. The system is substantially similar to the system 300, but comprises a plurality of connected delay rings 400₁-400ₙ (hereinafter collectively referred to as “delay rings 400”). Specifically, FIG. 4 illustrates a first delay ring 400₁ and a second delay ring 400ₙ. Each of the delay rings 400 comprises at least one processing unit 402₁-402ₙ (hereinafter collectively referred to as “processing units 402”). By using a plurality of connected delay rings such as the delay rings 400, one can adjust the storage capacity of a data stream processing system.

For instance, if one wished to expand the storage capacity of a system originally comprising only the first delay ring 400₁, one would construct the second delay ring 400ₙ and then set one of the processing units 402 in the second delay ring 400ₙ to “subscribe” to the output flow of a processing unit 402 in the first delay ring 400₁. This is illustrated in phantom by stream connection 404, by which a “first” processing unit 402₉ of the second delay ring 400ₙ subscribes to the output of a “last” processing unit 402₃ of the first delay ring 400₁. The stream connection between the “last” processing unit 402₃ of the first delay ring 400₁ and a “first” processing unit 402₄ of the first delay ring 400₁, to which the “last” processing unit 402₃ previously forwarded its output, is then terminated, as illustrated by broken stream connection 406. The “first” processing unit 402₄ of the first delay ring 400₁, which is now receiving no data as a result of the broken stream connection 406, is then set to “subscribe” to the output of a “last” processing unit 402ₙ of the second delay ring 400ₙ, as illustrated in phantom by new stream connection 408. The retention capacity of the data stream processing system is thus increased by adding processing units 402 to store and forward information units (payload).

Conversely, if one wanted to reduce the storage capacity of a system originally comprising both the first delay ring 400₁ and the second delay ring 400ₙ, one would first break the stream connection 404 between the “first” processing unit 402₉ of the second delay ring 400ₙ and the “last” processing unit 402₃ of the first delay ring 400₁. This forms a bottleneck of information units in the chain of processing units 402 from the “last” processing unit 402₃ of the first delay ring 400₁ and those processing units 402 upstream. Once the last information unit has left the “last” processing unit 402ₙ of the second delay ring 400ₙ, the “first” processing unit 402₄ of the first delay ring 400₁ is set to “subscribe” to the output of the “last” processing unit 402₃ of the first delay ring 400₁. This completes the first delay ring 400₁. The stream connection 408 between the “first” processing unit 402₄ of the first delay ring 400₁ and the “last” processing unit 402ₙ of the second delay ring 400ₙ is then broken, and the processing units 402 of the removed second delay ring 400ₙ are free for other use. Thus, the present invention enables scalable parallelization of data storage and retrieval by allowing storage to be sectionalized across multiple delay rings (each delay ring having at least one processing unit).

Thus, the present invention represents a significant advancement in the field of data stream processing. Embodiments of the invention provide many advantages over traditional data stream processing systems. By arranging processing units in a delay ring and allowing them to be raveled through advanced processing units, the “distance” between the advanced processing units and the delay ring storage can be minimized. This relieves network hops and congestion, thereby speeding connectivity for data storage and retrieval. Moreover, the system eliminates or reduces the need for costly disk storage and index table maintenance.

While the foregoing is directed to the illustrative embodiment of the present invention, other and further embodiments of the invention may be devised without departing from the basic scope thereof, and the scope thereof is determined by the claims that follow.

1. A system for processing a data stream, the data stream comprising a plurality of information units, each of the plurality of information units comprising a heavyweight portion and a lightweight portion, the system comprising:
a first set of processing elements configured for processing of at least the lightweight portion; and
a second set of processing units configured for storage of the heavyweight portion.

2. The system of claim 1, wherein the lightweight portion comprises at least one of: annotations and retrieval keys.

3. The system of claim 1, wherein the heavyweight portion comprises payload.

4. The system of claim 1, wherein the second set of processing units is configured substantially as at least one ring of processing units that store and forward the heavyweight portion in a cyclic manner.

5. The system of claim 4, wherein the second set of processing units is configured as at least two connected rings of processing units.

6. The system of claim 1, wherein the lightweight portion of an information unit is linked to the heavyweight portion of the information unit by a shared retrieval key.

7. The system of claim 6, wherein a processing element of the first set uses the retrieval key to obtain heavyweight data from a processing element of the second set.

8. The system of claim 1, wherein the second set discards the heavyweight portion when the first set discards the lightweight portion.

9. A method for processing a data stream, the data stream comprising a plurality of information units, the method comprising:
dividing each of the plurality of information units into a heavyweight portion and a lightweight portion;
processing at least the lightweight portion by a first set of processing elements; and
storing the heavyweight portion by a second set of processing units.

10. The method of claim 9, wherein the lightweight portion comprises at least one of: annotations and retrieval keys.

11. The method of claim 9, wherein the heavyweight portion comprises payload.

12. The method of claim 9, wherein the second set of processing units is configured substantially as at least one ring of processing units that store and forward the heavyweight portion in a cyclic manner.

13. The method of claim 12, wherein the second set of processing units is configured as at least two connected rings of processing units.

14. The method of claim 9, wherein the lightweight portion of an information unit is linked to the heavyweight portion of the information unit by a shared retrieval key.

15. The method of claim 14, wherein a processing element of the first set uses the retrieval key to obtain heavyweight data from a processing element of the second set.

16. The method of claim 9, wherein the second set discards the heavyweight portion when the first set discards the lightweight portion.

17. A method for increasing the storage capacity of a data stream processing system, the method comprising:
configuring a first plurality of processing units for storage of a heavyweight portion of an information unit, the first plurality of processing units being configured substantially as a ring of processing units that store and forward the heavyweight portion in a cyclic manner; and
connecting a second plurality of processing units to the first plurality of processing units.

18. The method of claim 17, the second plurality of processing units is configured substantially as a ring of processing units that store and forward the heavyweight portion in a cyclic manner.

19. The method of claim 17, wherein the connecting comprises:
configuring a first processing unit in the second plurality to subscribe to output of a first processing unit in the first plurality;
terminating a stream connection between the first processing unit in the first plurality and a second processing unit in the first plurality; and
configuring the second processing unit in the first plurality to subscribe to output of a second processing unit in the second plurality.
